(19) United States
(12) Patent Application Publication
(10) Pub. No.: US 2010/0232480 A1
(43) Pub. Date: Sep. 16, 2010

(54) Capacitance Compensation System

(76) Inventors: Amarjit Singh Bhandal, Northamptonshire (GB); Brian Young, Austin, TX (US)

Correspondence Address: TEXAS INSTRUMENTS INCORPORATED, P O BOX 655474, M/S 3999, DALLAS, TX, 75265, US

(21) Appl. No.: 12/626,619

(22) Filed: Nov. 26, 2009

Related U.S. Application Data
(60) Provisional application No. 61/219,631, filed on Jun. 23, 2009.

(30) Foreign Application Priority Data
Mar. 13, 2009 (GB) 0904387.8

(51) Int. Cl. H04B 1/38

(52) U.S. Cl. 375/219

(57) ABSTRACT

A semiconductor device is described. The device comprises a transmitter associated with a die; a package adapted to be coupled to the transmitter and operative for receiving a data signal from the transmitter, wherein the package comprises at least one package trace having at least one segment, and the segment is capacitive and is positioned a quarter wavelength away from the die; a channel adapted to be coupled to the package and operative for receiving the data signal from the package; and a receiver coupled to the channel and operative for receiving the data signal from the channel.

### CROSS REFERENCE TO RELATED APPLICATION(S)

The present application claims priority to jointly owned Great Britain Provisional Application corresponding to application number 0904387.8 entitled “Improved Package Traces with Reduced Impedance to Compensate for Capacitance at Output Nodes of IC Transceivers.” This provisional application was filed on Mar. 13, 2009. In addition, this application also claims priority to jointly owned U.S. Provisional Application corresponding to application No. 61/219,631 filed on Jun. 23, 2009.

### DESCRIPTION OF RELATED ART

With the evolution of electronic devices, there is a continual demand for enhanced speed, capacity and efficiency in various areas including communications and solid state devices. For solid state devices, improving performance depends not only on improving performance on associated dies, but also depends on improving performance of interconnects between the die (e.g., package). Consequently, there remain unmet needs relating to package designs that improve system performance.

### BRIEF DESCRIPTION OF THE DRAWINGS

The capacitance compensation system may be better understood with reference to the following figures. The components within the figures are not necessarily to scale, emphasis instead being placed upon clearly illustrating the principles of the invention. Moreover, in the figures, like reference numerals designate corresponding parts or blocks throughout the different views.

FIG. 1A illustrates data flow for the capacitance compensation system.

FIG. 1B is a cross-sectional view through a multi-layer package substrate described with reference to FIG. 1A.

FIG. 2A illustrates a portion of a package trace for one implementation for the capacitance compensation system.

FIGS. 2B-2C illustrate the impact of using the capacitance compensation system of FIG. 2A.

FIG. 3A illustrates an alternative capacitance compensation system having a single region of increased capacitance in contrast to the system of FIG. 2A.

FIGS. 3B-3C illustrate the impact of using the capacitance compensation system of FIG. 3A.

FIGS. 4A-4B illustrate the impact of using various implementations of the capacitance compensation system.

FIG. 5 illustrates an alternative data flow to the flow of FIG. 1A.

While the capacitance compensation system is susceptible to various modifications and alternative forms, specific embodiments have been shown by way of example in the drawings and subsequently are described in detail. It should be understood, however, that the description herein of specific embodiments is not intended to limit the capacitance compensation system to the particular forms disclosed. In contrast, the intention is to cover all modifications, equivalents, and alternatives falling within the spirit and scope of the capacitance compensation system as defined by this document.

### DETAILED DESCRIPTION OF EMBODIMENTS

As used in the specification and the appended claim(s), the singular forms “a,” “an” and “the” include plural referents unless the context clearly dictates otherwise. Similarly, “optional” or “optionally” means that the subsequently described event or circumstance may or may not occur, and that the description includes instances where the event or circumstance occurs and instances where it does not.

High-speed integrated circuit (IC) transceivers (e.g., Gigabit rate Serdes transceivers) are often implemented with a termination impedance, such as approximately 100 Ω differential impedance. These transceivers can connect to a transmission line (e.g., a package, printed circuit board (PCB), or the like) with a characteristic impedance of approximately 50 Ω. Since both ends of the transmission line are single-ended and approximately 50 Ω, the impedances will match the approximately 100 Ωdifferential impedance, which maximizes transmission while minimizing unwanted reflections. However, various circuit components (e.g., electro-static discharge (ESD) structures, pads for bump attach, and the like) at the output node of such transceivers, can contribute undesired parasitic capacitances that substantially modify the impedance at the transceiver output node to well below approximately 100 Ω differential. For example, 700 fF at the Nyquist frequency of 3.25 GHz for a 7.5 Gbps Serdes may have an impedance of approximately 70 Ω; this may pull the parallel combination with the termination down from approximate 100 Ω differentially to approximately 41 Ω differentially, which increases the amount of reflections.

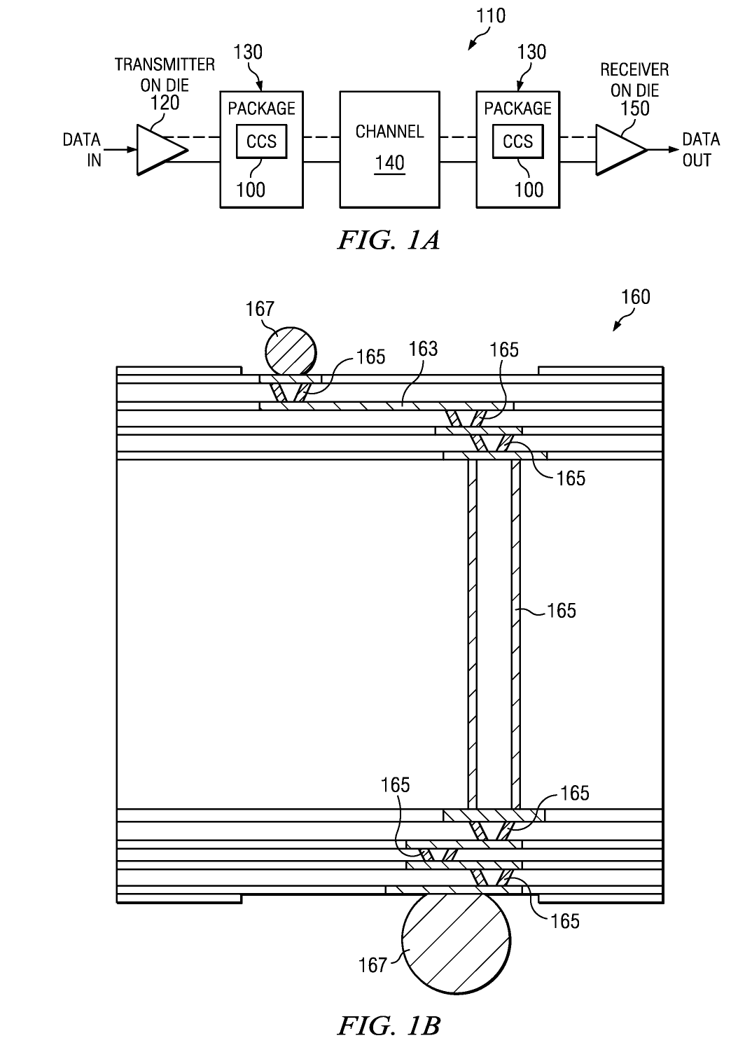

In light of this challenge, a capacitance compensation system 100 (see FIG. 1A) uses the impedance transformation characteristic of transmission lines to create a tuning inductance with design rules tolerant of manufacturing variations and practical design practice. Across a ¼ wavelength section of a transmission line, impedance inverts, causing an inductor to look capacitive and vice versa; in one implementation the frequency is nominally chosen as ½ the data rate (e.g., frequency=3.75 GHz for a 7.5 GBps link). The wavelength generally refers to the wavelength at which electromagnetic energy of a given frequency propagates through the material from which the package is constructed; this wavelength=c/(sqrt(Er)*f), where c=speed of light in vacuum, Er=relative dielectric constant of package material and f=frequency of propagating electromagnetic energy. In the capacitance compensation system 100, package traces are made capacitive along one or more small segments within approximately a ¼ wavelength of the die so that reflections from these discontinuities, once they have propagated back to the die, have a phase which makes them appear inductive. In addition, the capacitance compensation system 100 includes designing and constructing a strip line package trace to be more capacitive by making the trace wider.

Turning now to FIG. 1A, this figure illustrates data flow 110 for the capacitance compensation system (CCS) 100 and the role of the package in this flow. According to this flow, a transmitter 120 on a die (not shown) receives and then transmits data. The transmitter 120 may be any one of various kinds of transmitters such as Serdes, LVDS, HSTL or the like. In addition, the data the transmitter 120 receives may be any one of various types of data, such as serial bit pattern, sequences of parallel bits, or the like; in addition, this data may be received as a data signal. The location of the transmitter 120 on the die may vary and in some implementations the transmitter may be placed in very close proximity to the connection from the die to the package. After receiving the data in the form of a data signal, this transmitter sends a transmitted signal.

A package 130 receives the transmitted signal from the transmitter 120. This package 130 may be any one of various kinds of packages such as a flip-chip ball grid array, a multi-chip module, a chip-scale package, or the like. As the transmitted signal passes through this package, this package sends a first packaged signal. A channel 140 receives the first packaged signal. This channel may be any one of various kinds of channels such as a PCB and/or backplane interconnect, cable, or the like; alternatively, this channel may have any range of dimensions from approximately a few millimeters to approximately many meters. The channel sends a channel signal. The package 130 receives the channel signal and in turn transmits a second packaged signal. Since the package 130 includes the capacitance compensation system 100, the first packaged signal and the second package signal may be capacitance compensated signals. The second packaged signal may be sent to a receiver 150. This receiver may be any one of various kinds of receivers such as Serdes, LVDS, HSTL or the like.

The data flow 110 is merely one of many possible ways data can flow with the CCS 100. Alternative implementations may result by any one of the following. The channel 140 may consist of an interconnect path through one or more of the following components, or links: PCBs, backplane, connectors, sockets, and cables. In some implementations, there may be 50 links, 150 links, 400 links, or the like in a complete system with corresponding transmitters and receivers; in other words, these links would have many transmitters, links and receivers in parallel (e.g., parallel configuration). In the implementation shown in FIG. 1A, the transmitter 120 and the receiver 150 are implemented on die, but alternative implementations may result when either the transmitter 120 or the receiver 150 is off die; another alternative may occur when both the transmitter 120 and the receiver 150 is off die. For these implementations, either the transmitter 120 or the receiver 150 may remain a part of the package 130 even if one of those devices is off die.

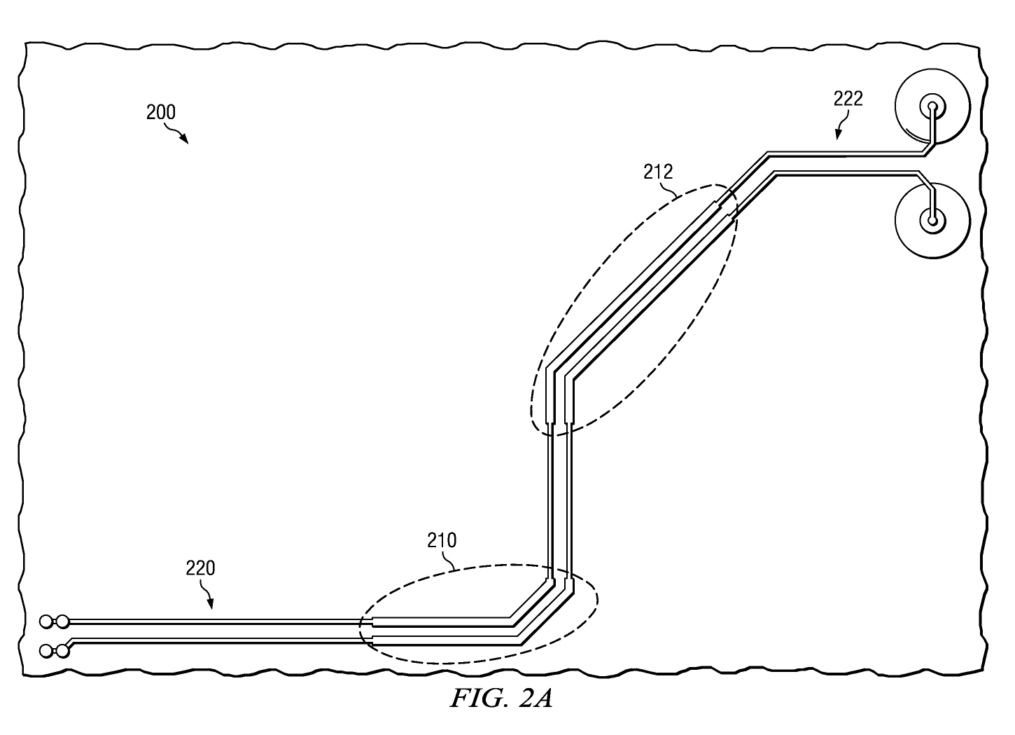

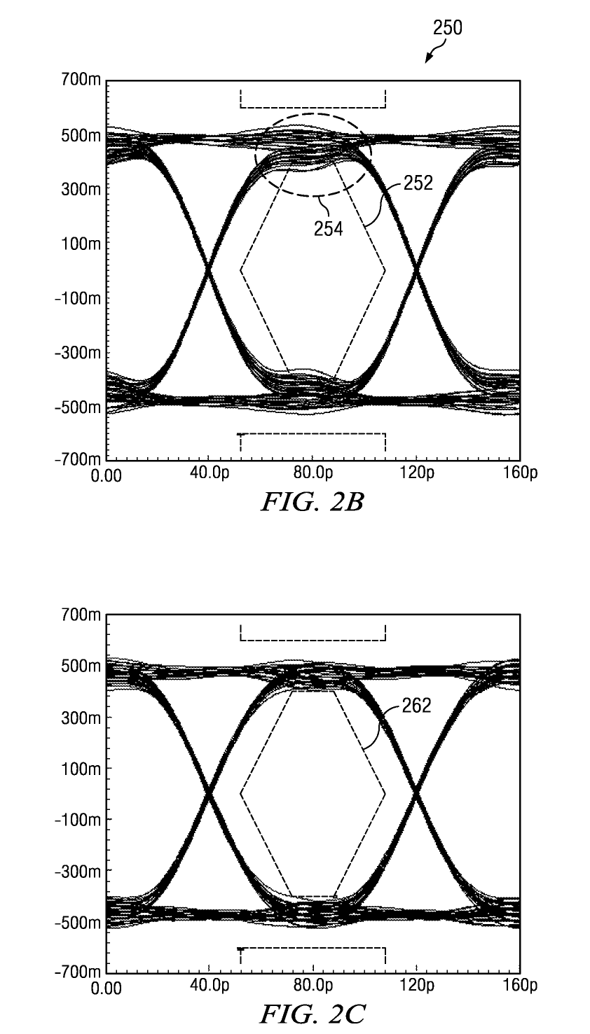

FIG. 1B is a cross-sectional view illustrating one implementation of the package 130 that is a multi-layer package substrate 160. The cross-sectional height of may be approximately 1 mm, while approximately 11.5 mm is the distance between the transmitter on a die placed at the centre of the package substrate and the ball 167 assigned to carry the signal from the said transmitter to the PCB. All numbers included in this application are primarily for illustrative purposes and may be changed without departing from the inventive concepts described. The capacitance compensation system 100 may include various structures, such as one or more package traces made up of short segments of varying width; segment 163 is an example of this type of segment. This segment is a lower impedance package trace that may improve the performance of high-speed, integrated circuit (IC) transceivers (e.g., transmitter 120 and receiver 150) both in terms of near-end eye shape and link Bit Error Rate (BER). Additionally, the capacitance compensation system (CCS) 100 may incorporate existing capacitive structures along package nets such as vias 165 and balls 167 and associated pads (e.g., pads 165-167) into the capacitive segments. Including the vias 165, balls 167, and associated pads both overcomes their previous limitations, while compensating for the transceiver output node capacitance. The CCS 100 is also applicable to packages with very short package nets (e.g., package nets less than ¼ wavelength, package nets implemented on a wafer scale, or chip scale packaging technologies). For these implementations, capacitive structures within the CCS 100 may be a part of the package, printed circuit board (PCB) interconnect, PCB net traces, or some combination of these, which is further illustrated with respect to FIG. 2A.

FIG. 2A illustrates a portion 200 of a package trace for one implementation for the capacitance compensation system 100. This portion may be in an organic package substrate with an associated relative dielectric constant (Er) described above. One skilled in the art will appreciate that there may be many 10's or 100's of links through each package with package net lengths varying over the following range: approximately 5 mm to approximately 30 mm. For some links, the package trace length may be greater than approximately ¼ wavelength, while others may be less. This length variation may be addressed by individually tuning each link, or portion 200. This tuning may be done by adjusting line lengths and line widths to maximize the eye opening, minimize jitter, and minimize the Bit Error Rate (BER).

For illustrative purposes only, the portion 200 may be described with specific numbers. The fundamental frequency, F0=½ of the data rate; so for an operational speed of 12 Gbps the fundamental frequency is 6 GHz. Consequently, the ¼ wavelength distance=c/(4*sqrt(Er)*F0); hence, the ¼ wavelength distance is approximately 6.8 mm. As a result, the portion 200 includes two sections 210-212 of increased capacitance. More specifically, these sections are 2 mm segments of approximately 50 μm wide traces at approximately 25 μm spacing, which is approximately twice as wide as the sections 220-222. The section 210 is approximately 3 mm from the die-end via stack; in contrast, the section 212 is approximately 6.5 mm from the die-end via stack (thus both sections 210 and 212 are within approximately ¼ wavelength of the die). Using the sections 210-212 of the CCS 100 with their double width means that the output signal compensates for the parasitic capacitance that may be associated with the output signal.

Turning now to FIGS. 2B-2C are plots of voltage vs. time, modulo the bit period, to create an eye diagram for a package with the CCS 100. The plot 250 includes a hexagon 252 that represents a region that should be free of signal for an eye mask setting associated with a desired performance level. In other words, the vertical axis of the eye diagram represents the amplitude of the signal being communicated. A binary signal may have two amplitude levels. The further apart the levels the easier it is for the receiver to tell one from the other and therefore correctly receive the message sent by the transmitter. The horizontal axis of the eye diagram is time. Each point along the time axis represent multiple points of time, which have been overlayed such that the width of the eye diagram matches two bit intervals and all time points which are exactly two intervals apart are plotted at the same x axis location. For an ideal eye diagram when the signal switches from one amplitude level to the other, these switching points should be coincident on the eye diagram (this would represent zero jitter).

In FIG. 2B, there is a region 254 where the left side of the eye extends into the hexagon 252. Unlike the plot 250, the plot 260 of FIG. 2C also has a corresponding hexagon 262 that represents a desired, or ideal, region. However, the plot 260 does not have a region corresponding to the region where the eye extends into the hexagon 262. Therefore, the eye for the package trace without the lower impedance segments associated with the capacitance compensation system 100 (i.e., plot 250) does not comply with desired design constraints. In plot 260, the eye has been tuned using the CCS 100 as described herein and avoids extending into that ideal region of the hexagon 262.

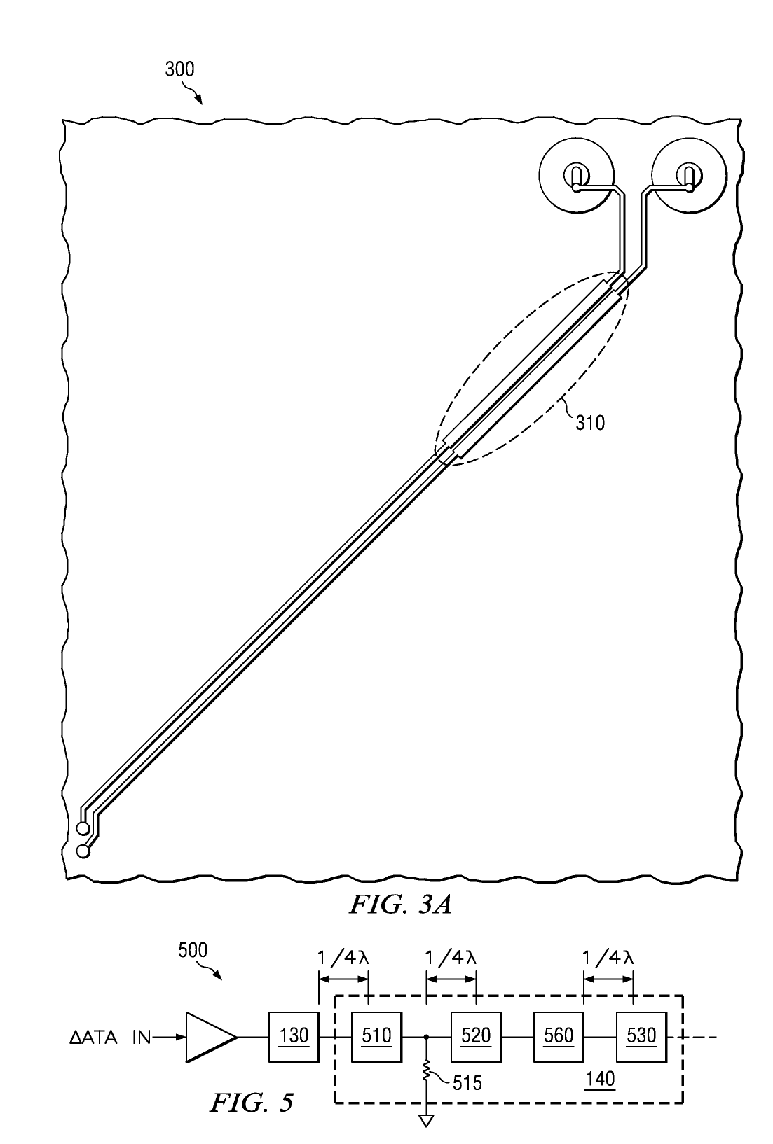

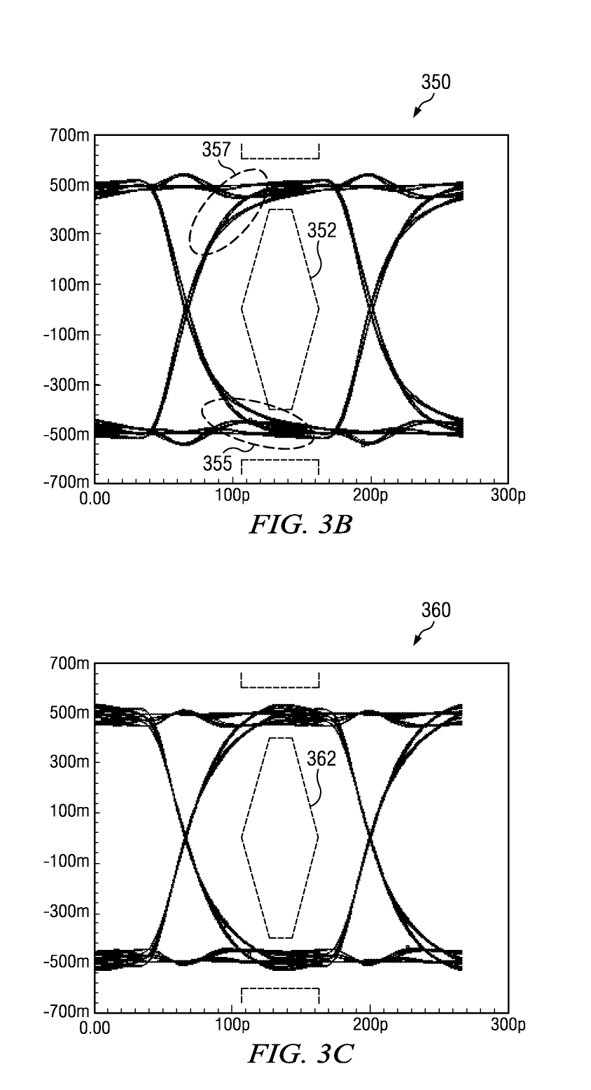

FIG. 3A is a diagram 300 of an alternative capacitance compensation system 100 having a single region 310 of increased capacitance. In this example, the target operational speed is approximately 7.5 Gbps in an organic package substrate, and the above-core routed net of length is approximately 9.5 mm. The fundamental frequency is approximately 3.75 GHz. This means ¼ wavelength distance=c/(4*sqrt(Er)*F0), or approximately 9.2 mm. Thus, the package trace pair in region 310 for the CCS 100 has one approximately 2 mm segment of approximately 50 μm wide traces at approximately 25 μm spacing; this region is approximately 5.75 mm from die-end via stack and a second region of capacitance is achieved by the PCB end via stack located approximately 9.6 mm from the die-end via stack. FIG. 3B is a plot 350 illustrating the behaviour of the eye of a package trace without the region 310 of CCS 100, described with reference to FIG. 3A. This plot includes two regions 355-357 that approach the hexagon 352, which is undesirable. In contrast, the plot 360 of FIG. 3C which uses the CCS 100. As indicated in this plot, the eye does not approach the hexagon 362, which means extra vertical margin allows either the transmitter voltage to be reduced for lower power consumption or for a longer channel to be used, where the larger losses cause a vertical reduction in the eye. It can also be said that 360 has more margin than 350.

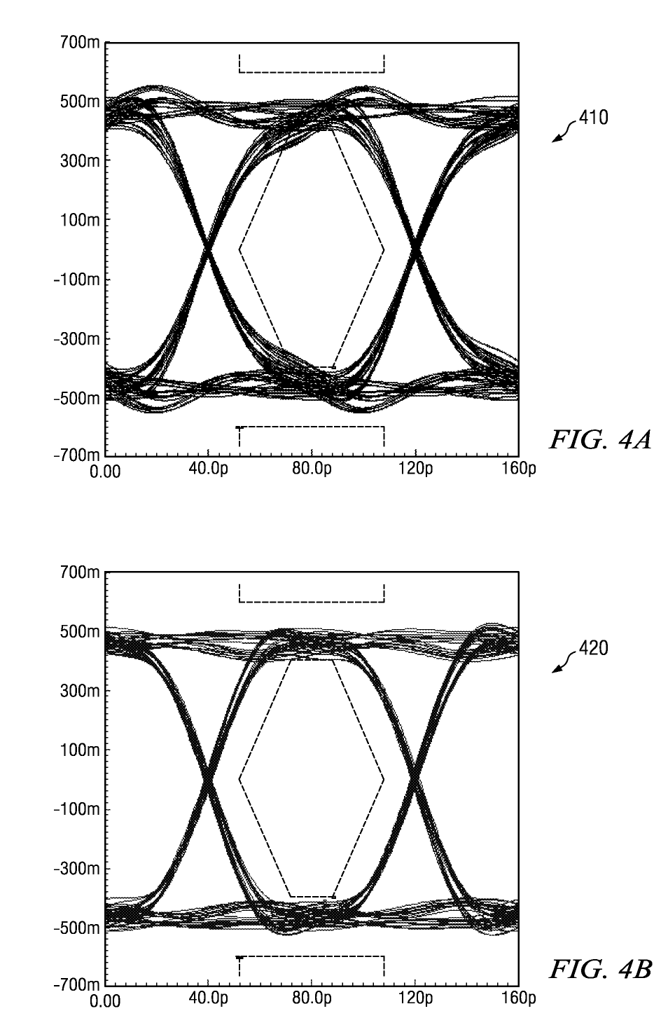

FIGS. 4A-4B illustrates the impact of using various implementations of the CCS 100. FIG. 4A a plot 410 illustrating an eye for CCS 100 with approximately 3.5 mm from the die of the first capacitive segment with the following dimensions: approximately 4 mm/75 μm/60 μm length/width/spacing. In contrast, FIG. 4B a plot 420 illustrating an eye for CCS 100 with 2.5 mm from the die of the two capacitive segments with the following dimensions: approximately 1.25 mm/75 μm/30 μm length/width/spacing. Plot 410-420 indicate that by adjusting the length, position, width and spacing of the capacitive transmission line segments of the CCS 100, the eye shape can be tuned for minimum jitter, maximum height or a combination of these. This tuning can be undertaken using an automated circuit optimizer on a link-by-link basis so that the eye for each link is individually optimised to compensate for the performance limiting characteristics of that specific link. One example of an automated circuit optimizer may be where the line lengths and/or widths are varied by an iterative computer algorithm such as steepest descent, that finds the optimal dimensions for best performance. Furthermore, bit-error-rate simulations indicate that implementing both transmit and receive package traces with the CCS 100 results in approximately 10% improvement in performance across a wide range of channels. The CCS 100 resolves the problem of undesired capacitance at the output node of IC transceivers—and can use this otherwise adversely impacting capacitance to gain advantage in shaping the signal eye.

Turning now to FIG. 5 this figure illustrates an alternative data flow 500 using the CCS 100. As described with reference to FIG. 1A, this implementation also has a package 130 and channel 140. Within this channel, there may be several links 510-530 that form the CCS 100; one or more of these links (e.g., link 510) may be composed of several segments, where one segment is capacitive and located about ¼ wavelength from 130. As described with other implementations, this ¼ wavelength may also be tuned. Between the segment 510 and the segment 520, there is a terminated impedance shown here as the resistor 515. This impedance device may be any type of impedance device such as an impedance of approximately 50 ohms. By including multiple segments within the channel 140, the CCS 100 described in this implementation is potentially usable at other sites where excess capacitance occurs.

There may be any number variations applicable to the flow 500 and is within the scope of the CCS 100. Some examples may include any of the follow: having any of the segments implemented with wider line widths on more than one package layer; implementing a segment as excess via capacitance, either incurred at a change in layer before the via transition to the BGA connection or at the BGA connection itself, having segments implemented by sections of transmission line with unequal line width; using segments in conjunction with a change in nominal impedance from 100 Ω differential to any other nominal impedance; using segments of compensating capacitance on transmission line types other than stripline, such as microstrip or buried microstrip used on top-layer routing; combining the segments with a combination of transmission line types, such as using microstrip routing on the top layer, then transitioning to stripline on buried layers; separating the ¼ wavelength section that includes segments from the excess capacitance with a section of transmission line for further tuning; placing segments on each side of an excess capacitance, such as at the connector 560; implementing the ¼ wavelength sections that include segments at a wavelength multiple of (n/2+¼) wavelength, where n=0, 1, 2, . . . , since impedance repeats every half wavelength. Additional variations may also include the following: including several ¼ wavelength sections targeting different harmonics; adding compensating capacitance through alternative means, such as ceramic chip capacitors, tightly coupled meander routing, and high dielectric constant dielectric overlays; and combining wider line widths, which implement compensating capacitance, with sections with narrower line widths, which implement excess inductance, to create a filter with additional tuning properties over and above those created by the initial compensating capacitance.

Since the CCS 100 transmission line behaviour may be accomplished using fractional wavelength sections, the impedance matching effect is frequency dependent. For signalling applications with bandwidth limiting encoding, such as Serdes (serializer/deserializer) with DC balancing, the CCS 100 enhances performance at the data rate for which it is optimized. At lower data rates, performance may be degraded, but extra margin is inherently available from the transmitter and receiver at the lower data rate, so the performance degradation due to the CCS 100 can be tolerated.

While the CCS 100 has been described with reference to Serdes, it may be used with other applications as well. For example, it is applicable to interfaces that use differential signalling especially when they are high speed, like Serdes. Interfaces that do not use differential signaling may be sensitive to supply noise, which may cause most of the performance degradation; this degradation may force the use of slower data rates. For these situations, the CCS 100 may also improve performance. But, designers may complete a cost benefit analysis and determine whether the benefits of implementing would outweigh the cost. In fact, the CCS 100 may be used on all interconnects where the transmitter is more than ¼ wavelength from the receiver at the frequency where the bulk of the signaling energy is concentrated. In other words, cases where the bulk of the energy is concentrated into a narrow band, then the ¼ wavelength optimization can affect enough frequency components to provide an overall benefit.

Unlike some alternative approaches, the CCS 100 is primarily passive and consumes little, if any, power or silicon area. This system generally includes one or more segments of package, and/or PCB interconnect; the interconnect impedance is generally lower than the impedance that terminates the transceiver and is approximately within ¼ wavelength distance from the die based on a target data rate. The interconnect segments within the CCS 100 may have an impedance which is lower than the impedance achieved with the minimum line width geometry of multi-layer package manufacturing processes. This facilitates easier implementation and more effective multi-layer packaging technologies. Thus, one can beneficially use existing capacitive structures along package interconnects, such as vias and balls plus associated pads, for gain. One can also fine tune performance with segments with higher impedance if the manufacturing technology permits.

Since this technique is implemented on the package rather than as part of the on-die transceiver it means that the same transceiver design can be used to generate a variety of waveform (eye) shapes targeted at different channel characteristics and this can be done as part of the system design cycle rather than as part of the transceiver design cycle. For more advanced packaging technologies such as Chip Scale Packaging or Wafer Scale Packaging for which package nets are shorter than ¼ wavelength, it is possible to implement the lower impedance interconnect segments along the PCB traces or connection between the PCB and package typically consisting of a board via and solder ball plus associated pads.

While various embodiments of the capacitance compensation system have been described, it may be apparent to those of ordinary skill in the art that many more embodiments and implementations are possible that are within the scope of this system. Although certain aspects of the capacitance compensation system may be described in relation to specific techniques or structures, the teachings and principles of the present system are not limited solely to such examples. All such modifications are intended to be included within the scope of this disclosure and the present capacitance compensation system and protected by the following claim(s).

1. A semiconductor device, comprising:
a transmitter associated with a die;
a package adapted to be coupled to the transmitter and operative for receiving a data signal from the transmitter, wherein the package comprises at least one package trace having at least one segment, and the segment is capacitive and is positioned within approximate a quarter wavelength away from the die;
a channel adapted to be coupled to the package and operative for receiving the data signal from the package; and
a receiver coupled to the channel and operative for receiving the data signal from the channel.

2. The semiconductor device of claim 1, wherein the package further comprises a second segment displaced from the first segment that is capacitive.

3. The semiconductor device of claim 1, further comprising a plurality of transceivers associated with a plurality of segments, wherein each transceiver is associated with a transceiver in a parallel configuration.

4. The semiconductor device of claim 3, wherein the length of at least one of the segments can be individually tuned.

5. The semiconductor device of claim 1, wherein at least one device selected from the group consisting of the transmitter and the receiver is not positioned on a die.

6. The semiconductor device of claim 1, further comprising a second capacitive segment as a part of a device selected from the group consisting of the printed circuit board interconnect, package, and net traces associated with the printed circuit board.

7. The semiconductor device of claim 1, wherein including at least one segment reduces power consumption associated with a transmitter voltage.

8. The semiconductor device of claim 1, wherein the channel further comprises at least one capacitive segment.

9. The semiconductor device of claim 3, further comprising an impedance device coupled to the channel.

10. The semiconductor device of claim 3, wherein at least one of the segments has a wider line width on more than one package layer.

11. A method for reducing undesirable capacitances associated with a transceiver, the method comprising the steps of:
transmitting a signal reflected of data received;
routing the signal through a package associated with the transceiver;
compensating for capacitance associated with an output node of the transceiver in response to routing the signal through the package,
wherein routing further comprises sending the signal through at least one capacitive segment within the package.

12. The method of claim 11 further comprising the step of individually tuning at least one capacitive segment when there are at least two capacitive segments within the package.
